(19) United States
(12) Patent Application Publication
(10) Pub. No.: US 2003/0224768 A1
(43) Pub. Date: Dec. 4, 2003

(54) Processor Re-Start Control

(75) Inventor: Regis Adjamah, Birmingham (GB)

Correspondence Address: MCGARRY BAIR PC, 171 MONROE AVENUE, N.W., SUITE 600, GRAND RAPIDS, MI, 49503, US

(73) Assignee: SENDO INTERNATIONAL LIMITED, Central, Hong Kong (CN)

(21) Appl. No.: 10/249,984

(22) Filed: May 23, 2003

(30) Foreign Application Priority Data
May 27, 2002 (GB) GB 02 12143.2

(51) Int. Cl. H04M 3/00

(52) U.S. Cl. 455/418; 455/420

(57) ABSTRACT

A method of handling a re-start of a first processor in a dual-processor system where the system includes a first processor performing a first set of functions operably coupled to a second processor performing a second set of functions. The method includes the steps of storing one or more initialization and/or configuration commands in a memory element, wherein the commands are sent by the second processor to the first processor to set an operation of said first processor. A message from the first processor indicates a re-start operation of the first processor, in response to which the one or more initialization or configuration commands are retrieved from the memory element. The first processor is then re-started with preferably the most-recent initialization or configuration setting so that the operational state of the first processor, following re-start, is as expected by the second processor.

### BACKGROUND OF INVENTION

1. Field of the Invention

The present invention relates to a method of handling a restart of a first processor and an error manager for carrying out the method. The present invention is applicable to, but not limited to, a method of handling a restart of a first processor in a mobile communications device and an error manager there for.

2. Description of the Related Art

Mobile communications devices are being provided with more and more functionality. In particular, so-called ‘Smart Phones’ are being provided with not only conventional cellular communications functionality, but also functionality resembling that of personal digital assistants (PDAs), and more.

In order to provide such additional functionality, whilst maintaining the ability to provide cellular communications functionality complying with the various standards and requirements, it is common to provide two processors within the communications device. In this way, the various features and functions of the device can be divided between the two processors, in what is effectively a dual-processing system.

For example, a first processor system, comprising a first processor, may be responsible for controlling communication with a network to which the mobile communications device is connected. For example, the first processor system, in this manner, would handle a protocol stack and signal processing, and control components such as an RF module, baseband/audio CODEC, battery manager, subscriber identification module (SIM) card reader, etc.

Meanwhile a second processor system, comprising a second processor, may be responsible for running man-machine interface (MMI) applications and controlling a display, keypad, universal serial bus (USB) and/or IrDA interfaces, etc.

For such a dual-processor system, in general the second processor system controls at least some of the configuration of the first processor system, and instructs the first processor system to perform various tasks.

Because of this, it is important that the first processor system is in an operational state expected by the second processor system. If, however the first processor restarts, essentially restarting all of the first processor system, when the second processor system is not expecting it, the first processor system is unlikely to be in a state expected by the second processor system following the restart operation.

In such a case, it is important that the first processor is in an operational state expected by the second processor after a re-start operation as, for example, the MMI running on the second processor controls many of the functions of the communication software on the first processor. Furthermore, it is useful to provide to the user an indication of available communication options that the user is able to select. If the first processor is not in an expected state, the MMI software of the second processor will not know what operations can be performed by the first processor in its present, state, nor determine how to change the state of the first processor (where required) in order to perform the operations.

There is therefore a need to provide an apparatus and method for handling a restart of the first processor such that the configuration of the first processor system following a restart operation is returned to a state expected by the applications running on the second processor.

Furthermore, if the second processor receives a signal or command indicating that the first processor has restarted, the second processor may force a restart of both processors in order for both processors to be in a ‘fresh’, and thereby aligned state.

This is particularly undesirable for devices where the second processor is responsible for running the MMI of the device. If the first processor restarts it is unlikely that a user will notice, unless it occurs during a call or similar. Hence, the first processor is generally able to restart without causing distress or annoyance to the user. However, if the second processor restarts itself, in response to the first processor re-start operation, the restart will be clearly noticeable to a user, which is undesirable.

Therefore, there is a further need for a method of and apparatus for preventing the second processor from realizing that the first processor has restarted and forcing a restart of both the first and second processors.

### SUMMARY OF INVENTION

According to a first aspect of the present invention, there is provided a method of handling a restart of a first processor in a dual-processor system, according to claim 1.

According to a second aspect of the present invention, there is provided a processor-controlled device including an error manager, according to claim 4.

According to a third aspect of the present invention, there is provided a method of handling a restart of a first processor in a dual-processor system, according to claim 9.

According to a fourth aspect of the present invention, there is provided a processor-controlled wireless communication device including an error manager, according to claim 12.

In summary, an error manager prevents the second processor from forcing a restart of both the first and second processors by intercepting the signals and/or commands identifying the restart of the first processor and preventing them from reaching the second processor.

Furthermore, the error manager of the preferred embodiment of the present invention returns the first processor to a state expected by the second processor by sending the initialization and/or configuration signals and/or commands to the first processor.

### BRIEF DESCRIPTION OF DRAWINGS

Exemplary embodiments of the present invention will now be described, with reference to the accompanying drawings, in which:FIG. 1 illustrates an example of a dual-processor device with which the preferred embodiment of the present invention may be implemented.

FIG. 2 illustrates a preferred process for handling commands received from a second processor according to the preferred embodiment of the present invention.

FIG. 3 illustrates a preferred process foran error manager to determine a first processor re-start operation and initiate an initialization/reconfiguration process according to the preferred embodiment of the present invention.

### DETAILED DESCRIPTION

The preferred embodiment of the present invention provides a method for handling a restart operation of a first processor. The method comprises the steps of monitoring signals sent from the first processor to a second processor, identifying a restart of the first processor from the signals being sent from the first processor to the second processor, intercepting the signals, and preventing them from reaching the second processor.

FIG. 1 illustrates, a dual-processor device 100, for example a mobile communications device, in which the preferred embodiment of the present invention may be implemented. The processor arrangement comprises a first processor 110, which forms a part of a first processor system (not shown), and a second processor 120, which forms part of a second processor system (not shown).

The first processor system may be responsible for controlling communication with a network to which the mobile communications device is connected, for example handling a protocol stack and signal processing. Furthermore, the first processor system preferably controls components (not shown) such as an RF module, baseband/audio CODEC, battery manager, subscriber identification module (SIM) card reader, etc.

The second processor system may be responsible for running a man-machine interface (MMI) and controlling a display, keypad, USB and/or IrDA interfaces etc.

For the illustrated embodiment, the mobile communications device 100 is compatible with the Global System for Mobile Communications standards. Thus, in use the first processor 110 has running thereon the necessary software 112 for controlling RF circuitry (not shown) etc for operating with a GSM network. Such software includes layer 1 and GSM protocol software, as is well known.

In use, a man-machine interface (MMI) software application 122 runs on the second processor 120. MMI software applications are well known, and provide, for example, a graphical interface to a user by way of a display (not shown) or the like. The MMI software application 122 also processes instructions received from the user by way of a keypad (not shown) or the like.

For the illustrated embodiment, the MMI software 122 is able to send and receive commands to/from the GSM software 112 running on the first processor 110, via a radio interface layer (RIL) 124. The RIL 124 converts commands passing between the two processors to/from a required format, and handles the sending and receiving of the commands.

It will be appreciated by those skilled in the art that software applications (not shown) running on the second processor 120, other than the MMI software 122, preferably also send receive commands to/from the GSM software 112 via the RIL 124.

It will be appreciated that the features so far described are for clarity only, and are provided as an example of a device in which the preferred embodiment of the present invention may be implemented. They are not intended as limiting on the scope of the present invention, which will now be described.

Also illustrated in FIG. 1 is an error manager 130 for implementing the method of the preferred embodiment of the present invention. The error manager 130 is located in the command path between the first processor 110 and the second processor 120. For the illustrated embodiment the error manager 130 is provided in the form of a software application running on the second processor, located ‘below’ the radio interface layer 124 in the command path to the first processor 110.

In this way, commands (and responses) passing between the two processors 110, 120 pass through the error manager 130. Advantageously, the error manager 130 is provided on or coupled to the second processor. In this manner, its operation is not halted during a re-start operation of the first processor. Furthermore, in this configuration, the error manager 130 is able to ‘handle’ any commands sent to the first processor from the second processor during the re-start operation of the first processor, in such a way as to keep the MMI software, etc., running smoothly.

The error manager 130 monitors commands passing between the first processor 110 and second processor 120, and identifies when a restart of the first processor 110 has taken place from the commands being sent from the first processor 110 to the second processor 120. The error manager 130 intercepts the commands identifying the restart of the first processor 110, and prevents them from reaching the second processor. In this way, the second processor 120 is kept unaware that the first processor 110 has restarted. In particular, the error manager 130 also filters out many of the error messages received from the first processor. For example, a number of error messages that may be sent by the GSM software in the first processor 110 are not serious and do not require the attention of the second processor or a reboot/re-start operation of the first processor.

Although the preferred embodiment of the present invention has been described in relation to the error manager monitoring commands, which for example may be in the form of AT commands passing between the two processors 110, 120, it will be appreciated that any other form of communication signals passing between the two processors 110, 120 could also be monitored by the error manager 130 as appropriate in order for the preferred embodiment of the present invention to be carried out.

By AT commands it is meant commands defined in GSM standard 07:07 “AT command set for GSM Mobile Equipment (ME)”.

Thus, the error manager 130 intercepts the commands identifying a restart of the first processor 110. In order for the first processor system to be returned to a state expected by the second processor system, i.e. the state at which the first processor system was in prior to the restart of the first processor 110, it is necessary for the first processor 110 to be provided with the necessary initialization and/or configuration commands. This is achieved by the error manager 130 retrieving the required initialization and/or configuration commands from an area of memory 140, and providing them to the first processor 110.

The error manager 130 preferably obtains the required initialization and/or configuration as described below.

As well as monitoring the commands passing from the first processor 110 to the second processor 120, the error manager 130 also monitors commands passing from the second processor 120 to the first processor 110. In this regard, the error manager 130 identifies initialization and configuration commands being sent to the first processor 110.

In accordance with the preferred embodiment of the present invention, the error manager 130 stores in memory 140 any configuration and/or initialization commands received, say from the second processor 120, before passing them on to the first processor 110. Preferably, the commands are stored in RAM, or another area of volatile memory that only retains information stored therein whilst power is provided thereto.

In this way, when the device 100 in which the two processors are provided is switched off the area of memory in which the commands are stored is cleared. This is preferable because on switching ‘on’ the device, both processors will be in a ‘fresh’ state, and the previously stored initialization and/or configuration commands will no longer be required.

In this way, after a restart of the first processor 110, the error manager 130 is able to retrieve the various initialization and/or configuration commands sent from the second processor 120 to the first processor 110 prior to the restart and resend them to the first processor 110. Thus, once all of the retrieved commands have been sent to the first processor 110 and executed, the first processor system will be in substantially the same state as before the restart of the first processor 110, and thereby in a state expected by the second processor 120.

Preferably, from the point at which the error manager 130 identifies that the first processor 110 has restarted to the point at which the first processor system is restored to a state expected by the second processor 120, the error manager 130 blocks/buffers any commands from the second processor 120. It is envisaged that the error manager may provide a suitable response to the second processor 120. For example, in the case of the illustrated embodiment, if the second processor 120 sends a command to the first processor 110 requesting that a call be initiated, the error manager 130 blocks/buffers the command and returns a response such as ‘No Service’. This allows the error manager to deceive the second processor 120 into thinking that the mobile communications device is unable to connect to the network.

Once the first processor 110 has executed the initialization and configuration commands sent by the error manager 130, and is therefore in a state expected by the second processor 120, the error manager 130 ceases blocking/buffering the commands sent from the second processor 120. If the commands were buffered, they are then forwarded to the first processor 110. The error manager 130 then resumes ‘pass-through’ mode, whereby it monitors the commands passing between the first processor and the second processor.

In accordance with an enhanced embodiment of the present invention, it is possible that the commands received from the first processor 110 that indicate a restart thereof may also be substantially the first commands received from the first processor. Such commands would follow the switching on, or powering up, of the device in which the two processors are provided. When this is the case, it is preferable that the error manager 130 is capable of differentiating between a re-start operation and a power‘on’ operation. In this regard, the error manager 130 preferably passes on this initial restart command to the second processor 120, allowing the second processor 120 to initially configure the first processor 110 following the mobile communications device 100 being switched on. Then, any subsequent restart commands received from the first processor can be intercepted as described above.

The differentiation between the initial restart command from the first processor 110 may be achieved by the use of a flag located in an area of volatile memory, for example the same area of memory 140 in which the error manager 130 stores the initialization and configuration commands received from the second processor 120. In this way, when the mobile communication device 100 is switched on, the volatile memory will be have been cleared, and the flag will be unset.

Hence, by retrieving a recently stored initialization or configuration command, preferably intercepted from the second processor to the first processor, the first processor may advantageously be re-started using the (most) recent initialization/configuration settings.

Furthermore, by intercepting a re-start command from the first processor, and blocking the command from being forwarded to the second processor, the second processor is advantageously precluded from knowing about the first processor re-start operation. Thus, the second processor will not attempt to re-start both processors, in order to align them both.

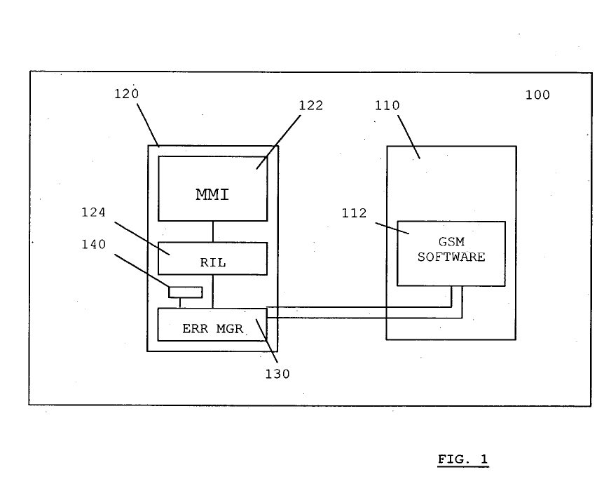

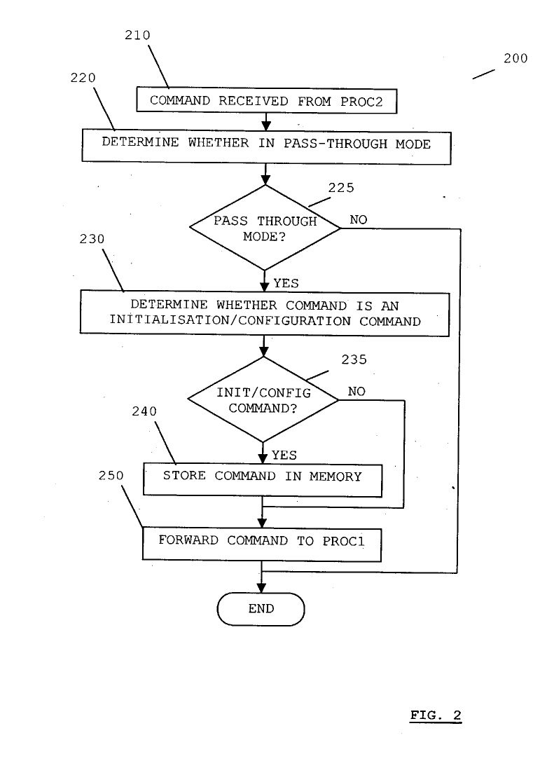

FIG. 2 illustrates a process 200 for the error manager to handle commands received from the second processor 120 in implementing a preferred method of the present invention.

The process begins at step 210, when the error manager receives a command from the second processor. Next, in step 220, the error manager determines whether it is operating in a pass-through mode, i.e. whether commands received from the second processor are to be passed on to the first processor.

If the error manager is not in a pass-through mode in step 225, i.e. commands received from the second processor are not to be passed on to the first processor, the command is discarded, and the process ends. As previously mentioned, the error manager may provide a response (not shown) to the second processor in order to fool the second processor into thinking that the command cannot be carried out for reasons other than because of the first processor restarting.

If the error manager is in a pass-through mode in step 225, the error manager determines, in step 230 whether the command is an initialization or configuration command. If the command is an initialization or configuration command in step 235, the error manager stores the command in memory, in step 240, before forwarding it on to the first processor, in step 250. The process then ends. If the command is not an initialization or configuration command, the error manager simply forwards it on to the first processor, without storing the command in memory, as shown in step 250. The process then ends.

In this manner, by storing initialization or configuration commands, preferably (but not necessarily) the most recently intercepted initialization or configuration command from the second processor to the first processor, the first processor may advantageously be re-started using these initialization/configuration settings.

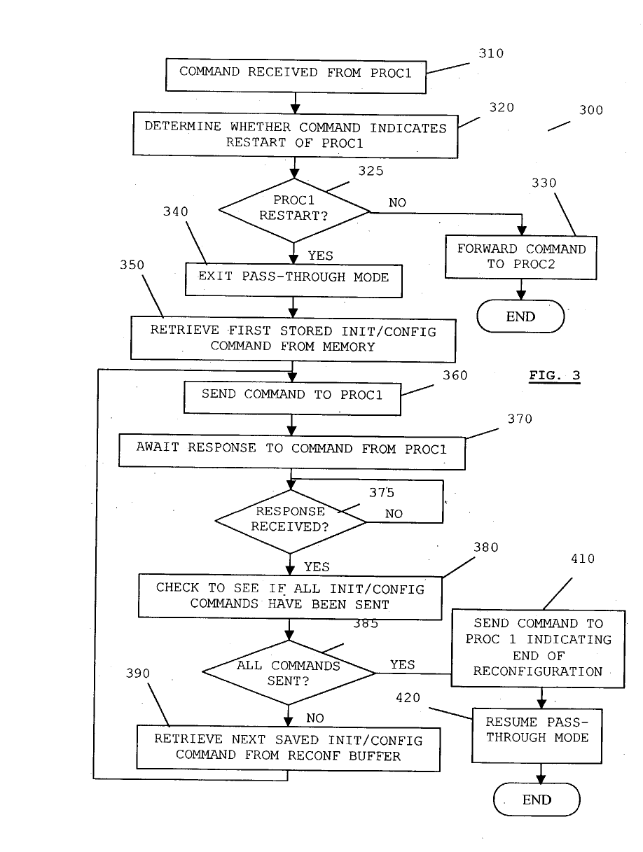

FIG. 3 illustrates a preferred process for an error manager to determine a first processor re-start operation and initiate an initialization/reconfiguration process in implementing a method of the preferred embodiment of the present invention.

The process starts at step 310, when the error manager receives a command from the first processor. Next, in step 320, the error manager determines whether the command indicates a restart operation of the first processor. Such a command may be in the form of the first processor requesting reconfiguration or initialization following a restart or any other appropriate command/request.

If the command does not indicate a restart of the first processor, the next step 330 is for the error manager to forward the command to the second processor 120. The process then ends.

However, if the command does indicate a restart of the first processor in step 325, the next step 340 is for the error manager to exit from a pass-through mode. This prevents the error manager from forwarding commands from the second processor to the first processor.

In the next step 350, the error manager retrieves the last stored initialization/configuration command from memory. Next, in step 360, the error manager sends the retrieved initialization/configuration command to the first processor. Having sent the initialization/configuration command to the first processor, the error manager then preferably waits, in step 370, for a response from the first processor stating that the first processor has received and executed the command.

Although not illustrated, if the error manager does not receive such a command in step 375, it will preferably resend the command to the first processor. This may be carried out, for example, at the expiration of a specific time limit, or on receipt of an invalid response from the first processor.

Once the error manager 130 receives a valid response from the first processor, it checks in step 380 to see if all initialization/configuration commands stored in memory have been sent to the first processor. If not all of the commands have been sent, in step 385, the error manager retrieves the next command stored in memory, in step 390, and repeats steps 360 to 380.

Once all of the initialization/configuration commands stored in memory have been sent to the first processor, the next step 410 (in FIG. 3) is for the error manager to send a command to the first processor indicating the end of the reconfiguration process. This instructs the first processor to resume normal operation.

Finally, in step 420, the error manager resumes operating a pass-through mode, such that commands received from the second processor will be passed on to the first processor. The reconfiguration process following a first processor re-start operation then ends.

Thus, for the process illustrated in FIG. 3 when applied to the enhanced embodiment, after determining that the command received is a restart command from the first processor in step 320, the error manager may check a flag to see if it is set.

If the flag is not set then this indicates that the restart command received from the first processor is the initial restart command following the mobile communications device being switched on. In this case, the error manager moves on to step 330, in FIG. 3 and forwards the command on to the second processor whilst preferably setting the flag.

If the flag is set, then this indicates that the restart command received from the first processor is not the initial restart command following the mobile communications device being switched on. In this case, the error manager moves on to step 340 in FIG. 3, and exits from pass-through mode.

Although the preferred embodiment of the present invention has been described for use in devices such as mobile communications devices, it is not limited to use there with, and mobile communications devices have been used solely for illustrative purposes. The method of handling a restart of a first processor in a dual-processor system and/or processor-controlled device, including an error manager of the preferred embodiment of the present invention, may equally be applied to any alternative device having equivalent dual or multiple processor, systems.

The method of handling a restart of a first processor in a dual-processor system and/or processor-controlled device including an error manager may be adapted and/or varied in any suitable way from the preferred embodiment herein described without narrowing the scope of the invention. The specific features herein described are only by way of example in implementing the method, and should not be taken to be limitations.

Thus, a method of handling a restart of a first processor in a dual-processor system and a processor-controlled device including an error manager are provided that alleviate firstly the problem of reconfiguring the first processor following a restart, and secondly the problem of preventing the second processor from realizing that the first processor has restarted and forcing a restart of both the first and second processors.

All other features and implementations herein described and/or illustrated in the drawings are considered solely as preferred additions and/or alternatives, and are not to be viewed as limiting the scope of the present invention.

Whilst the specific and preferred implementations of the embodiments of the present invention are described above, it is clear that one skilled in the art could readily apply variations and modifications of such inventive concepts.

1 A method of handling a restart of a first processor in a dual-processor system comprising a first processor performing a first set of functions operably coupled to a second processor performing a second set of functions, the method comprising the steps of:
storing one or more initialization or configuration commands in a memory element, wherein said commands are sent by said second processor to said first processor to set an operation of said first processor;
receiving a message from said first processor indicating a restart operation of said first processor;
retrieving said one or more initialization or configuration command from said memory element; and
re-configuring and/or re-initializing said first processor with the retrieved, preferably most-recent, initialization or configuration setting.

2 The method of handling a restart of a first processor in a dual-processor system according to claim 1, the method further comprising the step of:
blocking or buffering commands or instructions from said second processor during a re-configure and/or re-initialize operation of said first processor.

3 The method of handling a restart of a first processor in a dual-processor system according to claim 1 or claim 2, the method further comprising the steps of:
handling communication to a communication network by said first processor; and/or
handling man-machine interface operations by said second processor.

4 A processor-controlled device comprising:
a dual-processor system having a first processor performing a first set of functions; and a second processor, operably coupled to said first processor, performing a second set of functions;
an error manager application, located between said first processor and said second processor; and
a memory element, operably coupled to said error manager;
wherein said error manager intercepts and stores one or more initialization and/or configuration commands sent by said second processor to said first processor to configure an operation of said first processor in said memory element and said error manager retrieves and forwards said stored initialization or configuration commands to said first processor upon determining a re-start operation of said first processor.

5 The processor-controlled device according to claim 4, wherein the device is a wireless communication device and said error manager intercepts a message from said first processor to said second processor that indicates a re-start operation of said first processor and said error manager blocks said message, thereby preventing said second processor from realizing that said first processor has re-started.

6 The processor-controlled device according to claim 4 or claim 5, wherein the error manager is configured to differentiate between a re-start operation of a processor and a switch ‘on’ operation of the processor-controlled device, such that if the first processor re-start operation relates to a switch ‘on’ operation, the error manager allows the second processor to configure an operation of the first processor.

7 The processor-controlled device according to claim 6, wherein the error manager is configured to block or buffer commands or instructions from said second processor during a re-configure and/or re-initialize operation of said first processor.

8 The processor-controlled device according to claim 4 or claim 5, wherein said first processor handles communication to a communication network, for example a GSM network, and/or said second processor handles man-machine interface operations.

9 A method of handling a restart of a first processor in a dual-processor system comprising a first processor performing a first set of functions operably coupled to a second processor performing a second set of functions, the method comprising the steps of:
intercepting a message from said first processor to said second processor that indicates a re-start operation of said first processor;
blocking said message, thereby preventing said second processor from realizing that said first processor is re-starting; and
re-configuring and/or re-initializing said first processor.

10 The method of handling a restart of a first processor in a dual-processor system according to claim 9, the method further comprising the step of:
blocking or buffering commands or instructions from said second processor during a re-configure and/or re-initialize operation of said first processor.

11 The method of handling a restart of a first processor in a dual-processor system according to claim 9 or claim 10, the method further comprising the steps of:
handling communication to a communication network by said first processor; and/or
handling man-machine interface operations by said second processor.

12 A processor-controlled wireless communication device comprising:
a dual-processor system having a first processor performing a first set of functions and a second processor, operably coupled to said first processor, performing a second set of functions; and
an error manager application, located between said first processor and said second processor, wherein said error manager intercepts a message from said first processor to said second processor that indicates a re-start operation of said first processor and blocks said message, thereby preventing said second processor from realizing that said first processor has re-started.

13 The processor-controlled wireless communication device according to claim 12, wherein the error manager is configured to differentiate between a re-start operation of a processor and a switch ‘on’ operation of the processor-controlled wireless communication device, such that if the first processor re-start operation relates to a switch ‘on’ operation, the error manager allows the second processor to configure an operation of the first processor.

14 The processor-controlled wireless communication device according to claim 12 or claim 13, wherein the error manager is configured to block or buffer commands or instructions from said second processor during a re-configure and/or re-initialize operation of said first processor.

15 The processor-controlled wireless communication device according to claim 12 or claim 13, wherein said first processor handles communication to a communication network, for example a GSM network, and/or said second processor handles man-machine interface operations.
